(19) United States
(12) Patent Application Publication
(10) Pub. No.: US 2026/0089274 A1
(43) Pub. Date: Mar. 26, 2026

(54) COMPUTER PROGRAM PRODUCT, INFORMATION PROCESSING APPARATUS, AND METHOD OF CONTROLLING INFORMATION PROCESSING APPARATUS FOR ENABLING FAX PREVIEW WITH STANDARD DRIVER

(71) Applicant: CANON KABUSHIKI KAISHA, Tokyo (JP)

(72) Inventor: KENICHIROU HARUTA, Chiba (JP)

(21) Appl. No.: 19/303,801

(22) Filed: Aug. 19, 2025

(30) Foreign Application Priority Data
Sep. 24, 2024 (JP) 2024-165127

(51) Int. Cl. H04N 1/00

(52) U.S. Cl. CPC H04N 1/0044; H04N 1/00482

(57) ABSTRACT

An information processing apparatus enables preview of an image based on facsimile transmission data before the data is transmitted via facsimile, in a configuration where a standard driver is used to control facsimile transmission. The information processing apparatus includes an operating system and a computer program product configured to support a standard driver provided by the provider of the operating system. A facsimile setting is received through an advanced setting screen, and an image based on facsimile transmission data generated according to the facsimile setting is displayed on a display of the information processing apparatus as a preview, prior to transmission of the facsimile transmission data by an image forming apparatus which is able to communicate with the information processing apparatus.

### BACKGROUND

### Field of the Technology

The present disclosure relates to a computer program product, an information processing apparatus, and a method of controlling the information processing apparatus.

### Description of the Related Art

An information processing apparatus is known that causes an image processing apparatus to transmit generated facsimile (fax) transmission data via fax. The information processing apparatus includes a display and controls it to display, for example, a fax setting user interface (UI) for instructing an image processing apparatus connected to the information processing apparatus to perform a fax transmission process (see Japanese Patent Application Laid-Open No. 2019-74906).

In Windows®, general-purpose software (hereinafter referred to as a “standard driver”) is available for use with various image processing apparatuses provided by different manufacturers. Such a standard driver is preinstalled in the operating system (OS) and becomes usable simply by connecting any image processing apparatus to an information processing apparatus equipped with the OS. Therefore, there is no need to separately install a manufacturer-specific printer driver, which is highly convenient. On the other hand, since the standard driver is designed to support a wide range of image processing apparatuses from different manufacturers, it only offers standard functions, and manufacturer-specific functions cannot be utilized.

One of the manufacturer-specific functions is, for example, a fax preview function. The preview function allows a user to view an image based on fax transmission data on the screen before performing fax transmission. This enables the user to check whether the intended data is to be sent prior to fax transmission.

However, when a standard driver is used, the fax preview function is not available. Accordingly, the user cannot check an image based on fax transmission data before performing fax transmission.

### SUMMARY

Embodiments described herein are directed to technology that enables a user to preview an image based on fax transmission data prior to fax transmission in a configuration where a standard driver is used to control fax transmission.

In one embodiment, a computer program product is configured to support a standard driver provided by a provider of an operating system. The computer program product includes a memory having stored thereon computer-executable instructions which, when executed by a processor of an information processing apparatus, cause the information processing apparatus to receive a facsimile setting. The instructions further cause the information processing apparatus to display, on a display of the information processing apparatus, an image based on facsimile transmission data generated according to the facsimile setting, before causing an image forming apparatus which is able to communicate with the information processing apparatus to transmit the facsimile transmission data via facsimile.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram schematically illustrating an example of the hardware configuration of a host computer serving as an information processing apparatus according to an embodiment.

FIGS. 2A and 2B are block diagrams each schematically illustrating an example of the software configuration of the host computer illustrated in FIG. 1.

FIGS. 3A to 3F are diagrams each illustrating an example of a screen displayed on a display illustrated in FIG. 1.

FIGS. 4A and 4B are diagrams each schematically illustrating an example of a print setting screen displayed on the display illustrated in FIG. 1.

FIG. 5 is a flowchart illustrating the procedure of a PDC editing process performed by a function extension unit illustrated in FIG. 2B.

FIG. 6 is a diagram illustrating an example of capability information of a printer acquired from the printer illustrated in FIG. 1.

FIG. 7 is a diagram illustrating an example of a list of functions supported by an extension application illustrated in FIG. 2B.

FIG. 8 is a diagram illustrating an example of a list of functions supported by a general-purpose printing software illustrated in FIG. 2B.

FIG. 9 is a sequence diagram illustrating an example of a fax transmission control process performed by the host computer and the printer illustrated in FIG. 1.

FIG. 10 is a diagram illustrating an example of an image displayed as a preview when a setting value for a cover sheet is set to “ON” on an advanced settings screen illustrated in FIG. 3B.

FIGS. 11A and 11B are diagrams each illustrating an example of an image displayed as a preview when a setting value for image quality is set on the advanced settings screen illustrated in FIG. 3B.

FIGS. 12A and 12B are diagrams each illustrating an example of an image displayed as a preview when a setting value for error diffusion function is set on the advanced settings screen illustrated in FIG. 3B.

FIGS. 13A and 13B are diagrams each illustrating an example of an image displayed as a preview when a setting value for layout function is set on the advanced settings screen illustrated in FIG. 3B.

FIG. 14 is a flowchart illustrating the procedure of a support process performed by the extension application illustrated in FIG. 2B.

FIG. 15 is a sequence diagram illustrating another example of the fax transmission control process performed by the host computer and the printer illustrated in FIG. 1.

### DESCRIPTION OF THE EMBODIMENTS

Example embodiments will be described in detail with reference to the accompanying drawings. It should be noted that the following embodiments are provided for illustrative purposes only and are not intended to limit the scope of the disclosure. While multiple features are described in the embodiments, the disclosure is not limited to embodiments that incorporate all such features, and various combinations of these features may be contemplated as appropriate. Furthermore, in the drawings, like reference numerals designate like or corresponding parts, and duplicative descriptions thereof are omitted to avoid redundancy.

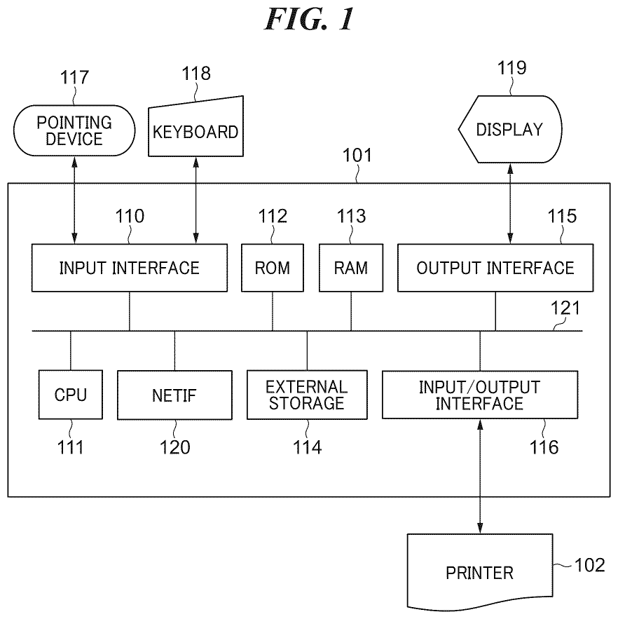

FIG. 1 is a block diagram schematically illustrating an example of the hardware configuration of a host computer 101 serving as an information processing apparatus according to an embodiment.

As illustrated in FIG. 1, the host computer 101 includes an input interface 110, a CPU 111, a ROM 112, a RAM 113, an external storage 114, an output interface 115, an input/output interface 116, and a network interface (NETIF) 120, which are interconnected via a bus 121. Input devices such as a keyboard 118 and a pointing device 117 are connected to the input interface 110. A display device such as a display 119 is connected to the output interface 115. The network interface 120 is configured to control data transfer with external devices via a network.

The ROM 112 stores an initialization program. The external storage 114 stores application programs, an operating system (OS), print data generation software, and various other data. The RAM 113 is used, for example, as a work memory during execution of the various programs stored in the external storage 114, enabling these programs to operate in the host computer 101.

In this embodiment, the CPU 111 operates according to the procedures of programs stored in the ROM 112, thereby implementing the functions of the host computer 101 and the processes illustrated in the flowcharts, as described below. The host computer 101 is connected to a printer 102, which serves as an image forming apparatus, via the input/output interface 116. Although the host computer 101 and the printer 102 are illustrated as separate devices in FIG. 1, they may be integrated as a single information processing apparatus. The display 119 displays a print setting screen and an advanced settings screen described below. In this embodiment, the printer 102 is described as an electrophotographic digital multifunction peripheral (MFP) having multiple functions such as copying, printing, and faxing. However, the printer 102 is not limited to such a digital MFP and may instead be a device that uses another printing method, such as inkjet printing. Additionally, the host computer 101 may be a desktop personal computer, a notebook computer, or a smartphone.

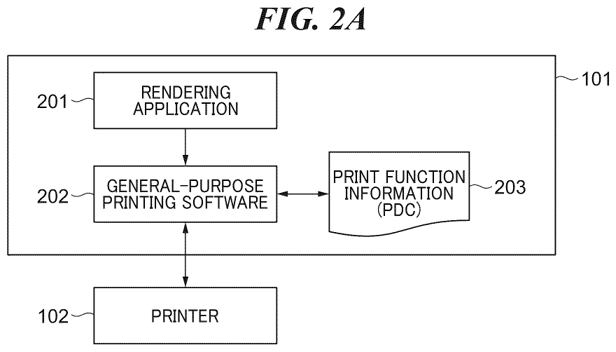

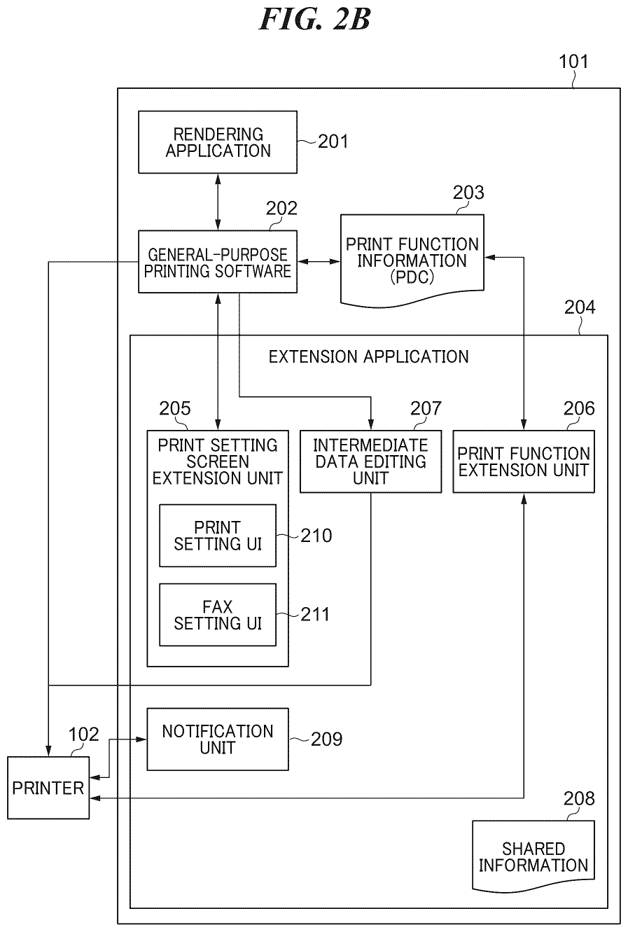

FIGS. 2A and 2B are block diagrams each schematically illustrating an example of the software configuration of the host computer 101 illustrated in FIG. 1. In this embodiment, the host computer 101 is assumed to be equipped with Microsoft® Windows® 11 as its operating system, by way of example.

FIG. 2A is a block diagram schematically illustrating the software configuration of the host computer 101 without an extension application 204 installed.

As illustrated in FIG. 2A, the host computer 101 includes a rendering application 201 and general-purpose printing software 202 as software components. The operations of these software components are implemented by the CPU 111 executing programs stored in the external storage 114. The host computer 101 also includes print function information 203.

The rendering application 201 is software used to create content (rendering data) to be printed, and may be, for example, a word processing application or a spreadsheet application. Upon receiving a print request or a fax transmission request from a user, the rendering application 201 issues a job execution instruction to the OS. This instruction includes print setting information for instructing the operations of the general-purpose printing software 202 and the printer 102. The print setting information is also referred to as a PrintTicket (hereinafter, “PT”). A PT is a file that contains print setting information described in XML format.

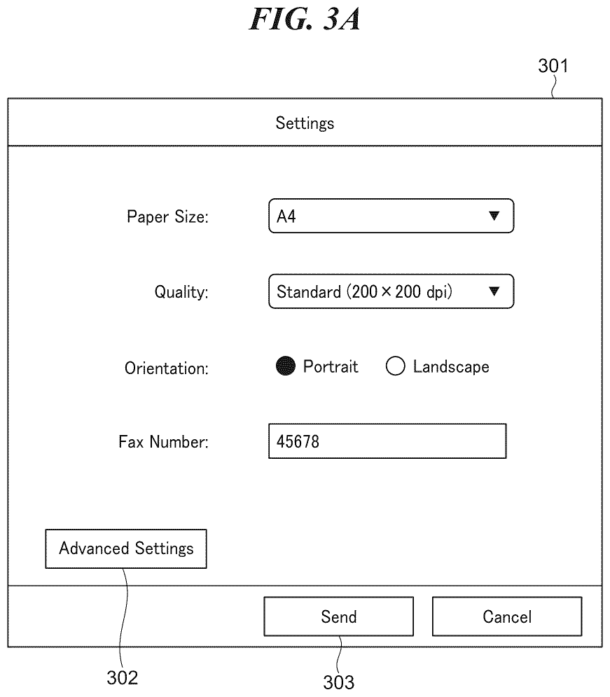

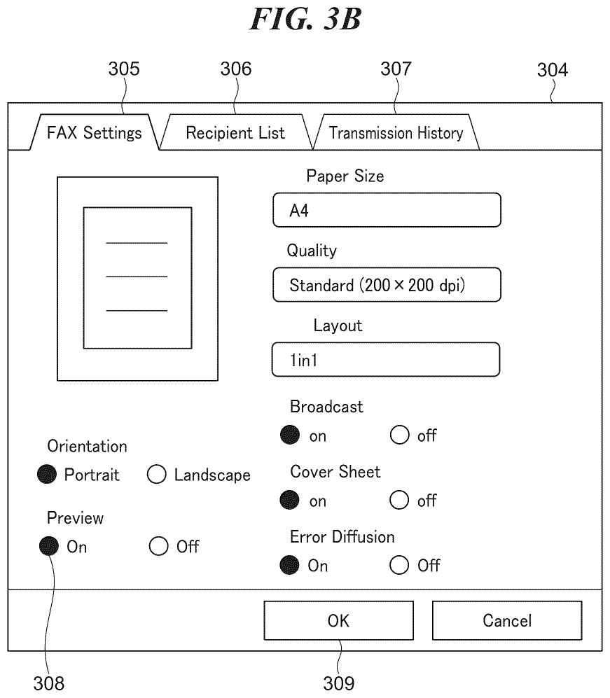

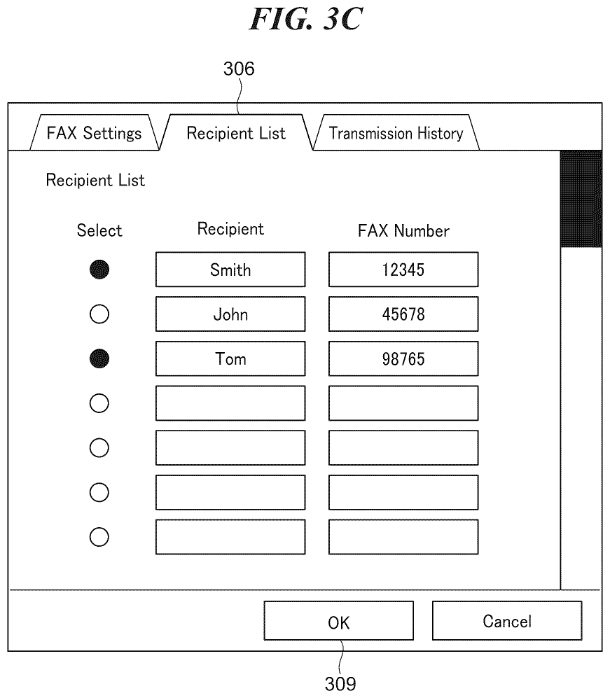

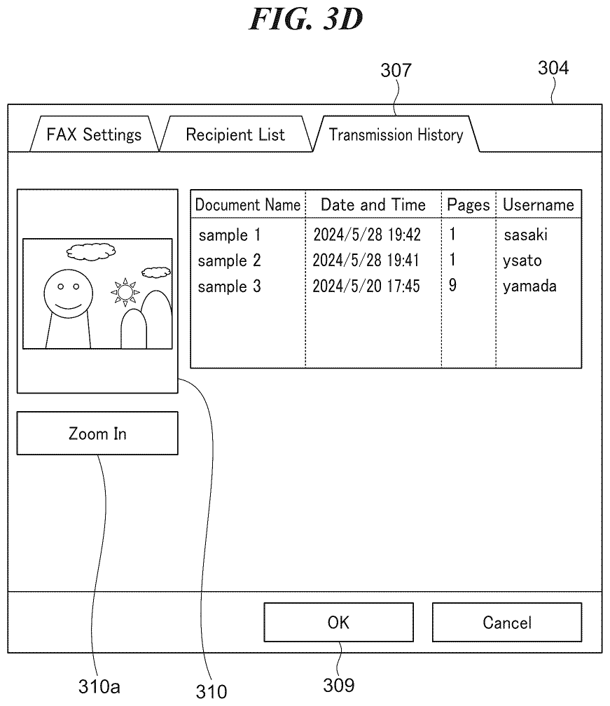

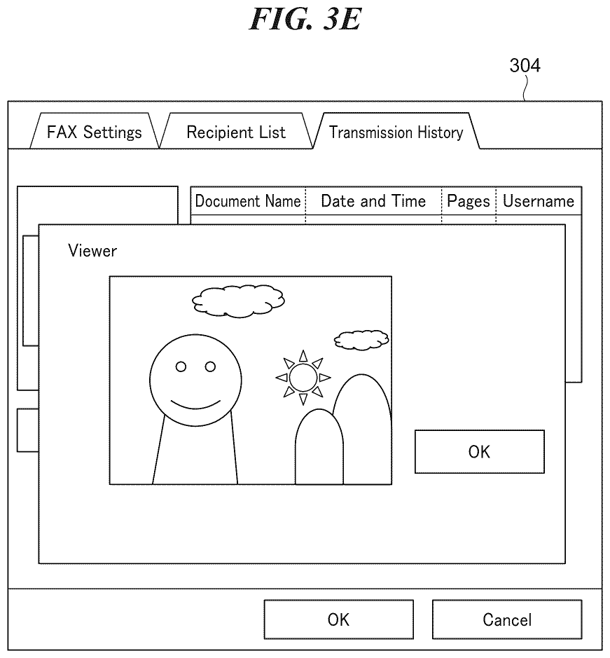

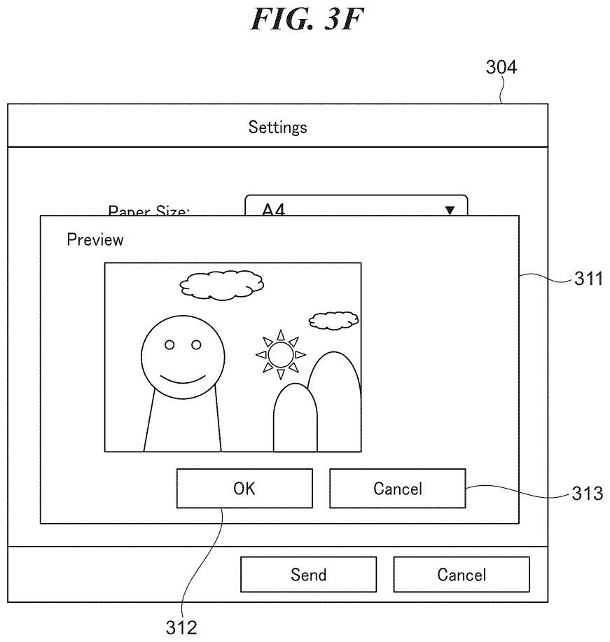

The rendering application 201 can display a print setting screen provided by any of the general-purpose printing software 202, the OS, or the rendering application 201 itself to output a PT. When an advanced settings button is pressed on the print setting screen, the general-purpose printing software 202 displays an advanced settings screen on the display 119 of the host computer 101. The configuration of the print setting screen and the advanced settings screen will be described later with reference to FIGS. 3A to 3F. The advanced settings screen includes setting items representing configurable print functions and their respective setting values according to the capability information of the general-purpose printing software 202. The capability information is also referred to as PrintCapabilities (hereinafter, “PC”). The general-purpose printing software 202 determines the PC based on the print function information 203.

The print function information 203 is also referred to as Print Device Capabilities (PDC). The PDC 203 is data that describes all configurable print functions and their setting values, as well as any mutually exclusive relationships among the setting values. The PDC 203 is included in a configuration file of the general-purpose printing software 202 and is stored as a non-editable file in the external storage 114. Alternatively, the PDC 203 may be dynamically generated by the general-purpose printing software 202 or the OS of the host computer 101. Specifically, the general-purpose printing software 202 or the OS of the host computer 101 acquires attribute data of the printer 102 from the printer 102 and generates the PDC 203 based on attribute information contained in the acquired attribute data. The attribute data of the printer 102 is obtained as a response to issuing a Get-Printer-Attributes operation, defined in the Internet Print Protocol (IPP), to the printer 102. This response includes attribute information indicating functions that can be specified on the printer 102 (i.e., printer capabilities) and setting values associated with the attribute information. The response is stored in the RAM 113. Note that when the PDC 203 is dynamically generated, the generated PDC 203 is editable.

By dynamically generating the PDC 203 as described above, the general-purpose printing software 202 enables the user to specify print functions and fax functions that are supported by the software and available on the printer 102 connected to the host computer 101. In other words, even if a printer connected to the host computer 101 has different functions or is developed by a different manufacturer, the user can specify print functions and fax functions that are supported by the general-purpose printing software 202 and available on the connected printer. Here, an example will be described in which the general-purpose printing software 202 is implemented using the IPP Class Driver included in Windows® 11. The IPP Class Driver is a printer driver that performs printing according to the specification of a standard printing protocol called Internet Print Protocol (IPP) and is included in the OS package. The IPP Class Driver is not a printer-specific driver tailored to the model of the printer 102 but a standard class driver that can be commonly used with different printers. The IPP Class Driver acquires capability information of the printer 102 connected to the host computer 101 and generates the PDC 203 based on the capability information so that the user can specify print functions supported by the printer 102. However, since the IPP Class Driver does not support manufacturer-specific functions, it does not allow the user to specify the manufacturer-specific functions, which are available on the printer connected to the host computer 101. One of the manufacturer-specific functions is, for example, a fax preview function. The fax preview function allows the user to preview an image based on generated fax transmission data before transmitting the data via fax.

When a job execution instruction is issued by the rendering application 201, a module of the OS in the general-purpose printing software 202 generates intermediate data (also referred to as input data). The data output from the rendering application 201 is either in the Graphic Device Interface (GDI) format or in the XML Paper Specification (XPS) format. As an example, a case will be described in which the general-purpose printing software 202 is implemented using the IPP Class Driver and the rendering application 201 outputs data in the GDI format. In this case, the OS of the host computer 101 converts the GDI format data output from the rendering application 201 into data in the XPS format. The intermediate data includes rendering data, which is information representing an image to be formed on a sheet, and a PT set by the user.

The general-purpose printing software 202 converts the acquired intermediate data into print data or fax transmission data and sends the converted data to the printer 102. The fax transmission data is data to be transmitted by the printer 102 to one or more destination devices specified using the IPP protocol. The fax transmission data includes one or more specified destinations as well as data on a generated cover sheet.

The printer 102 performs printing on a sheet based on the print data received from the general-purpose printing software 202. At this time, the printer 102 operates according to print setting attribute information included in the print data and forms the rendering data included in the print data on the sheet. The print setting attribute information includes attribute information and corresponding setting values for specifying sheet size (e.g., A4, B5, etc.), sheet orientation, and the like. For example, when the print setting attribute information includes attribute information specifying a sheet size of A4 and a setting value indicating that it is enabled, the printer 102 performs printing on an A4-sized sheet.

The printer 102 is also equipped with a fax communication function. The printer 102 acquires fax transmission data generated by the extension application 204 from the extension application 204 and transmits the fax transmission data via fax to a device specified by the user.

A description will now be given of the software configuration of the host computer 101, in which the extension application 204 is installed.

FIG. 2B is a block diagram schematically illustrating the software configuration of the host computer 101 with the extension application 204 installed. Any configurations and processes not specifically mentioned in connection with FIG. 2B are the same as those described with reference to FIG. 2A.

As illustrated in FIG. 2B, the host computer 101 includes, as a software component, the extension application 204, in addition to the rendering application 201 and the general-purpose printing software 202 described above. The operations of these software components are implemented by the CPU 111 executing programs stored in the external storage 114.

The extension application 204 is software that supports the general-purpose printing software 202 provided by the provider of the OS of the host computer 101 and is not pre-installed in (i.e., not bundled with) the OS. Therefore, the user needs to operate the host computer 101 to download and install the extension application 204 from a server via the Internet. Alternatively, the extension application 204 may be automatically installed when the printer 102 is connected to the host computer 101. Specifically, when the printer 102 is connected to the host computer 101, the OS of the host computer 101 acquires device identification information from the printer 102. The OS of the host computer 101 may download and install the extension application 204 corresponding to the acquired device identification information from a server via the Internet. In other words, the general-purpose printing software 202 and the extension application 204 are retained as separate files on the host computer 101.

Although the general-purpose printing software 202 and the extension application 204 may each be updated to a newer version, such updates occur at different timings. That is, the timing at which the host computer 101 acquires the general-purpose printing software 202 differs from the timing at which it acquires the extension application 204. In addition, the host computer 101 acquires the general-purpose printing software 202 and the extension application 204 through different triggers. When the extension application 204 is installed, the OS of the host computer 101 associates the extension application 204 with the general-purpose printing software 202 and the printer 102.

The extension application 204 includes a print setting screen extension unit 205, a print function extension unit 206, an intermediate data editing unit 207, and a notification unit 209. The extension application 204 also includes shared information 208 that can be accessed by all of the units. The shared information 208 is implemented as either a file stored in the external storage 114 or data stored in the RAM 113. The extension application 204 writes to and reads from the shared information 208 by using an application programming interface (API) provided by the OS of the host computer 101.

The extension application 204 may terminate its operation each time a unit has finished processing. In such cases, the OS of the host computer 101 launches the extension application 204 each time a request to use any of the units is received.

Furthermore, the extension application 204 may cancel the operation of a unit during its processing. If such cancellation occurs, the job being processed in the print queue is deleted by the OS of the host computer 101.

Upon receiving a fax transmission request from the user, the rendering application 201 issues a fax transmission instruction to the OS of the host computer 101. In the configuration of FIG. 2B, as in the configuration of FIG. 2A, the rendering application 201 can display a print setting screen. In the configuration of FIG. 2B, an advanced settings screen provided by the extension application 204 is displayed. Specifically, the print setting screen extension unit 205 of the extension application 204 provides the advanced settings screen to be displayed. The print setting screen extension unit 205 also stores, in the shared information 208, setting values specified by the user on the advanced settings screen. The print setting screen extension unit 205 causes the display 119 to display a print setting UI 210 for configuring print settings and a fax setting UI 211 for configuring fax settings.

The intermediate data editing unit 207 acquires intermediate data from the general-purpose printing software 202, converts the intermediate data into print data or fax transmission data, and then sends the converted data (print data or fax transmission data) to the printer 102. In addition, the intermediate data editing unit 207 acquires advanced setting information from the shared information 208 and adds the advanced setting information to the print data or fax transmission data. Upon receiving the print data, the printer 102 performs printing on a sheet based on the print data. Upon receiving the fax transmission data, the printer 102 transmits the fax transmission data via fax to a designated device. Note that the method of converting the intermediate data into print data or fax transmission data is not limited to the one described above.

The extension application 204 may be configured to acquire fax transmission data generated by the general-purpose printing software 202 and add advanced setting information to the fax transmission data. In the configuration of FIG. 2B as well, there may be cases where the user does not specify the fax preview mode. In such cases, as in the configuration of FIG. 2A, the general-purpose printing software 202 may send the fax transmission data to the printer 102 without passing it through the extension application 204.

The print function extension unit 206 is capable of editing the PDC 203 generated either by the general-purpose printing software 202 or by the OS of the host computer 101. This allows the print function extension unit 206 to add to the PDC 203 functions provided by the extension application 204, functions supported by the printer 102 but not supported by the general-purpose printing software 202, and mutually exclusive relationships among setting values for print functions. The OS of the host computer 101 activates the print function extension unit 206 when the extension application 204 is first associated with the printer 102 and the general-purpose printing software 202. The OS of the host computer 101 may also activate the print function extension unit 206 at other times, such as when the OS of the host computer 101 is started.

The notification unit 209 is capable of displaying a notification to the user in response to an error occurring in the printer 102. For example, when a paper-out error occurs in the printer 102, the general-purpose printing software 202 detects it. The OS of the host computer 101 then displays a message on the display 119 using a notification function called a “toast notification,” which is a feature of the OS. When the user clicks on the toast notification, the notification unit 209 of the extension application 204 is invoked by the OS of the host computer 101, causing the UI screen of the notification unit 209 to be displayed. The UI screen of the notification unit 209 displays, for example, detailed information about the paper-out error and instructions for refilling paper.

An example of the fax setting UI 211 and the print setting UI 210 displayed on the display 119 of the host computer 101 will be described below.

In this embodiment, when it is determined that the capability information of the printer 102 includes a fax function, i.e., when the printer 102 supports fax functionality, the print setting screen extension unit 205 displays the fax setting UI 211 on the display 119.

FIG. 3A is a diagram illustrating an example of a fax setting screen 301, which serves as the fax setting UI 211 illustrated in FIG. 2B. The fax setting screen 301 allows the user to configure setting items such as paper size, image quality, paper orientation, and the recipient's fax number. The fax setting screen 301 also includes an advanced settings button 302 and a send button 303. When the user selects the advanced settings button 302, the screen on the display 119 switches to an advanced settings screen 304 illustrated in FIG. 3B. When the user selects the send button 303, a preview 311 illustrated in FIG. 3F (described later) is displayed in an overlay on the fax setting screen 301.

FIG. 3B is a diagram illustrating an example of the advanced settings screen 304 displayed on the display 119 by the extension application 204 illustrated in FIG. 2B. In the example of FIG. 3B, a tab 305 is selected on the advanced settings screen 304.

The advanced settings screen 304 includes, in addition to the aforementioned setting items such as paper size, image quality, and paper orientation, further setting items such as broadcast transmission, cover sheet, layout, error diffusion, and preview. The layout function is a function to arrange data for multiple pages on a single sheet for printing. The broadcast transmission function is a function that allows the same fax transmission data to be transmitted to multiple different destinations specified by the user through a single transmission instruction. The error diffusion function is a function that uses a dithering technique to simulate intermediate colors in a process of reducing the number of colors or tones in an image.

When the user selects a tab 306 on the advanced settings screen 304, a screen illustrated in FIG. 3C is displayed on the display 119. This screen allows the user to select one or more fax numbers from a recipient list previously registered in the RAM 113. When a transmission is instructed with multiple recipients or destinations selected on this screen, a broadcast transmission is performed, whereby the same fax transmission data is sent to the selected destinations. The general-purpose printing software 202 does not support functions corresponding to the setting items that are not included in the fax setting screen 301 displayed by the general-purpose printing software 202 (e.g., broadcast transmission, cover sheet, recipient list). In this embodiment, the host computer 101 acquires fax capability information from the printer 102, and the extension application 204 controls the display of the advanced settings screen 304 based on the acquired capability information. Accordingly, the host computer 101 can receive settings for functions based on the capability information (e.g., broadcast transmission, cover sheet, recipient list).

When the user selects a tab 307 on the advanced settings screen 304, a screen illustrated in FIG. 3D is displayed on the display 119. This screen displays a list of previously transmitted fax transmission data based on a history table. The screen includes information such as the document name, transmission date and time, number of pages transmitted, and username. When a job is selected on this screen, the fax transmission data transmitted in the selected job is displayed, as indicated by a view 310 in FIG. 3D. Additionally, when the user presses a zoom-in button 310a in FIG. 3D, the fax transmission data is displayed in an enlarged view, as illustrated in FIG. 3E.

FIG. 3F is a diagram illustrating an example of a screen displayed when the user selects the send button 303. When the user selects the send button 303, the preview 311 is displayed in an overlay on the fax setting screen 301. An OK button 312 is a button to instruct the continuation of a fax transmission process. A cancel button 313 is a button to instruct the interruption or cancellation of a fax transmission process.

In this embodiment, when it is determined that the capability information of the printer 102 does not include a fax function, i.e., when the printer 102 does not support fax functionality, the print setting screen extension unit 205 displays the print setting UI 210 on the display 119.

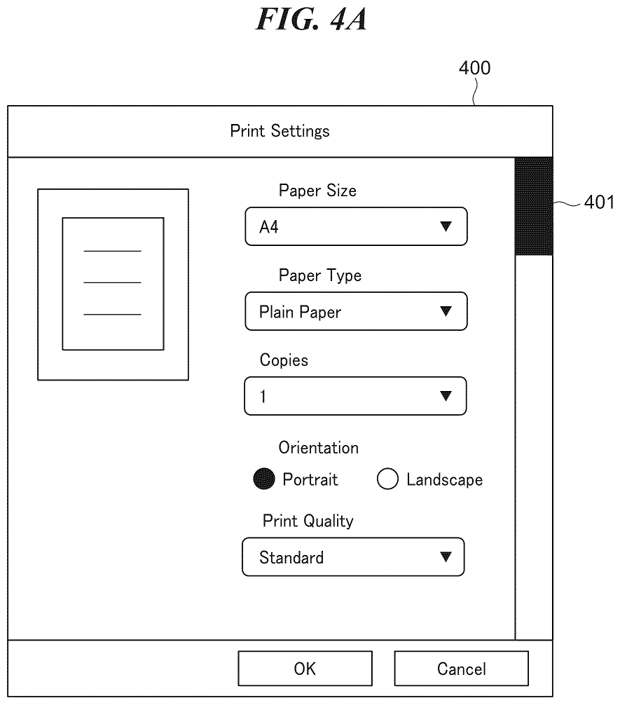

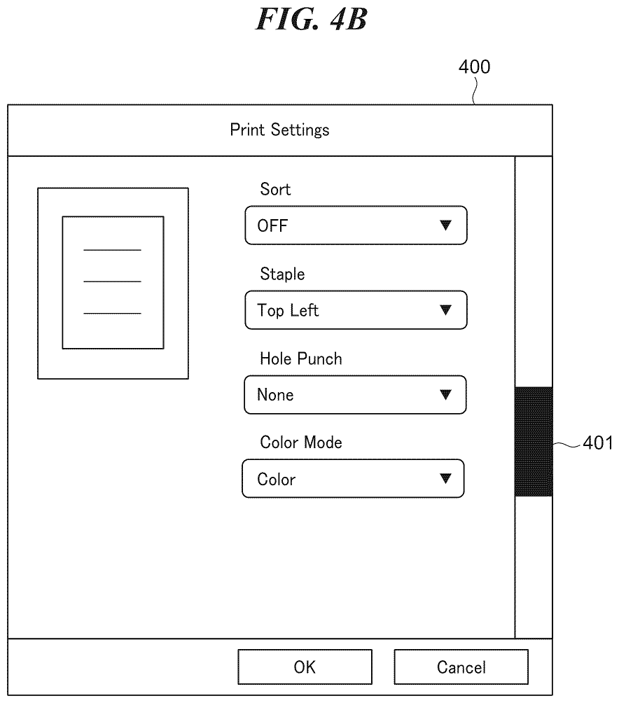

FIG. 4A is a diagram illustrating an example of a print setting screen 400, which serves as the print setting UI 210 illustrated in FIG. 2B. The user can operate a scroll bar 401 on the print setting screen 400 to configure additional setting items not depicted in FIG. 4A (see, for example, FIG. 4B).

A description will now be given of the editing of the PDC 203 by the intermediate data editing unit 207.

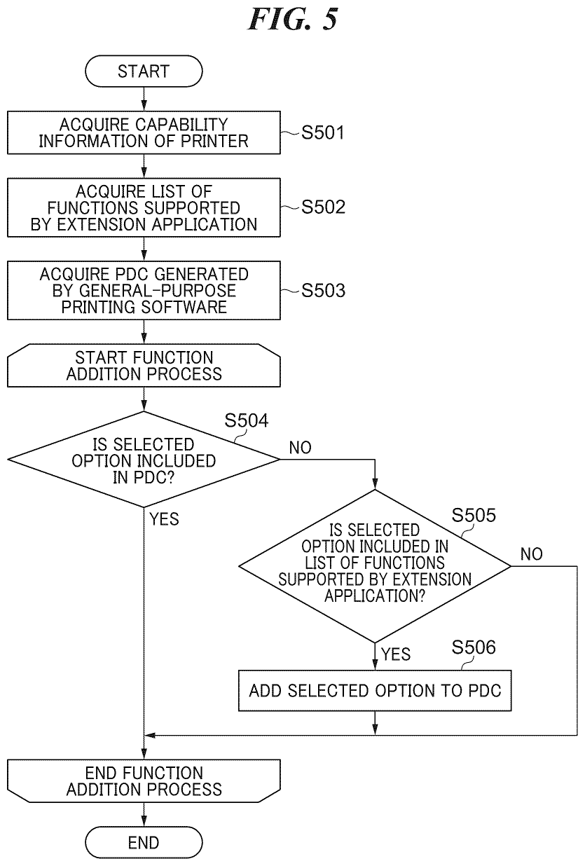

FIG. 5 is a flowchart illustrating the procedure of a PDC editing process performed by the intermediate data editing unit 207 illustrated in FIG. 2B. The intermediate data editing unit 207 performs the PDC editing process under the control of the CPU 111.

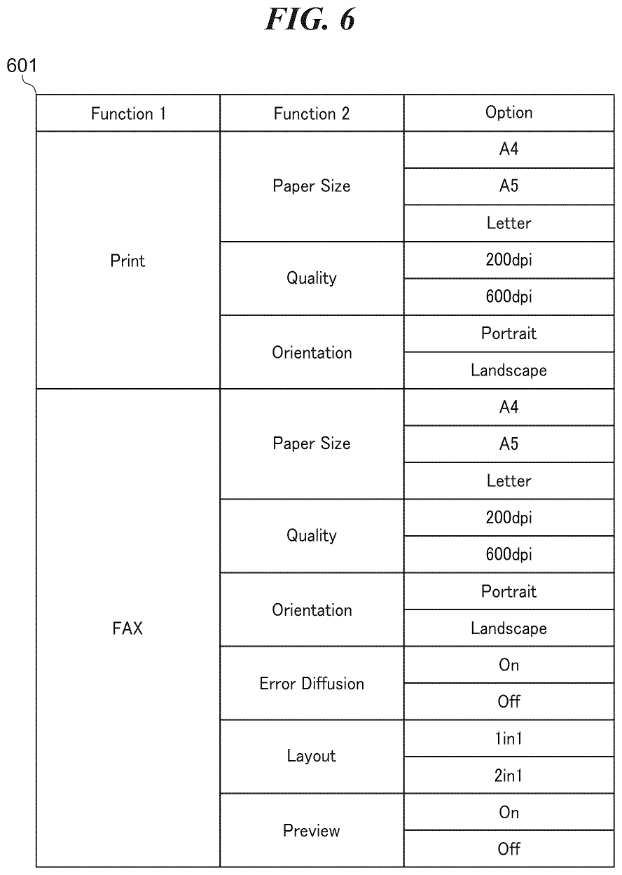

Referring to FIG. 5, first, in step S501, the intermediate data editing unit 207 acquires capability information of the printer 102 from the printer 102. The capability information of the printer 102 is contained in a response to an IPP Get-Printer-Attributes operation issued to the printer 102. The capability information of the printer 102 includes attribute information indicating functions that can be specified on the printer 102 and setting values associated with the attribute information. FIG. 6 is a diagram illustrating an example of capability information 601 of the printer 102 acquired from the printer 102. As illustrated in FIG. 6, information such as a fax image quality function and setting values (options) that can be specified for each function are acquired from the printer 102.

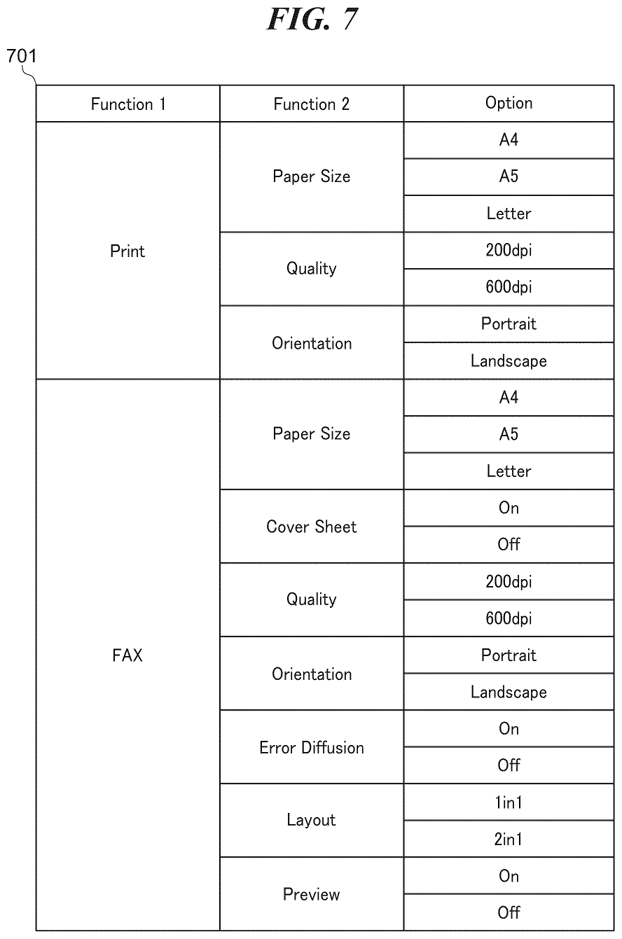

Next, in step S502, the intermediate data editing unit 207 acquires, from the shared information 208, a list of functions supported by the extension application 204. In this embodiment, the shared information 208 contains a list of functions supported by the extension application 204; specifically, all functions that can be processed by the extension application 204 and their corresponding setting values are recorded therein. Table 701 in FIG. 7 represents an example of a list of functions supported by the extension application 204. The list of functions supported by the extension application 204 may be updated, for example, through updates to the extension application 204.

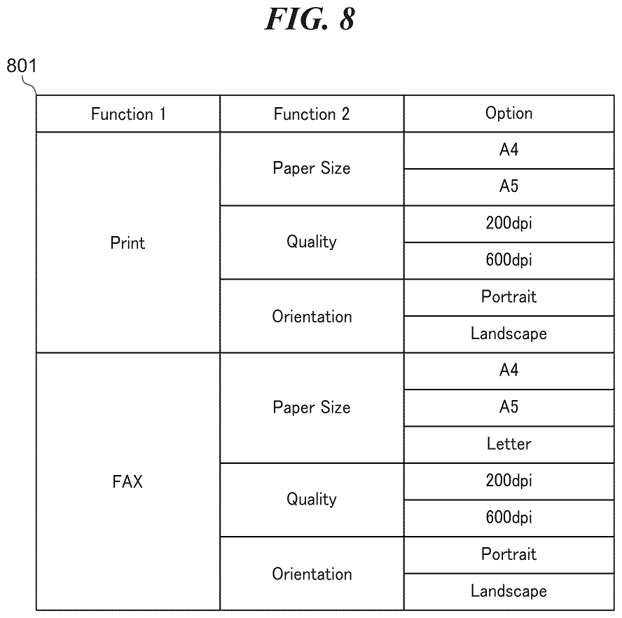

Next, in step S503, the print function extension unit 206 acquires the PDC 203 created by the general-purpose printing software 202 from the OS. The general-purpose printing software 202 creates the PDC 203 based on the capability information 601 of the printer 102 that the general-purpose printing software 202 has acquired from the printer 102. The PDC 203 created by the general-purpose printing software 202 includes, from the capability information 601 of the printer 102, only information on functions supported by the general-purpose printing software 202; it does not include information on functions not supported by the general-purpose printing software 202. Table 801 in FIG. 8 represents an example of a list of functions supported by the general-purpose printing software 202. For example, the capability information 601 of the printer 102 includes “Letter” as an option for paper size in the print functions; however, the general-purpose printing software 202 does not support this option, as illustrated in FIG. 8. Therefore, the PDC 203 acquired in step S503 does not include information on this option. As also illustrated in FIG. 8, since the general-purpose printing software 202 does not support the fax preview function either, the PDC 203 acquired in step S503 likewise does not include information on options related to the fax preview function. The print function extension unit 206 adds function or option information to this PDC 203, thereby enabling the extension application 204 to compensate for the lack of functionality in the general-purpose printing software 202. The print function extension unit 206 can also remove unnecessary function or option information from the PDC 203 created by the general-purpose printing software 202.

Next, the print function extension unit 206 performs a function addition process. Specifically, the print function extension unit 206 performs steps S504, S505, and S506. The function addition process is repeatedly performed for each option of the functions recorded in the capability information 601 of the printer 102 acquired in step S501. In this embodiment, the function addition process is repeated for a total of 20 items in the capability information 601 illustrated in FIG. 6, ranging from “A4,” an option for paper size in the print functions, to “Off (no preview),” an option for preview in the fax functions. The print function extension unit 206 selects one of the options from the capability information 601 of the printer 102 acquired in step S501.

In step S504, the intermediate data editing unit 207 determines whether the selected option is included in the PDC 203 generated by the general-purpose printing software 202. For example, assume that “A4,” an option for paper size in the fax functions, is selected from the capability information 601 of the printer 102. Since, as illustrated in FIG. 8, “A4” is supported by the general-purpose printing software 202, “A4” is included in the PDC 203 generated by the general-purpose printing software 202. In such a case, it is determined in step S504 that the selected option is included in the PDC 203 generated by the general-purpose printing software 202. On the other hand, assume that “On,” an option for preview in the fax functions, is selected from the capability information 601 of the printer 102. Since, as illustrated in FIG. 8, “On” is not supported by the general-purpose printing software 202, “On” is not included in the PDC 203 generated by the general-purpose printing software 202. In such a case, it is determined in step S504 that the selected option is not included in the PDC 203 generated by the general-purpose printing software 202.

If it is determined in step S504 that the selected option is included in the PDC 203 generated by the general-purpose printing software 202, the intermediate data editing unit 207 selects the next option and repeats step S504 for that next option. When the determination in step S504 is made for the last option in the capability information 601 of the printer 102 acquired in step S501 (e.g., “Off” in FIG. 6), the function addition process ends, and the PDC editing process is completed.

If it is determined in step S504 that the selected option is not included in the PDC 203 generated by the general-purpose printing software 202, the process proceeds to step S505.

In step S505, the intermediate data editing unit 207 determines whether the selected option is included in the list of functions acquired in step S502, i.e., the list of functions supported by the extension application 204. If it is determined that the selected option is not included in the list of functions acquired in step S502, the function addition process ends, and the PDC editing process is completed. If it is determined that the selected option is included in the list of functions acquired in step S502, the process proceeds to step S506.

In step S506, the intermediate data editing unit 207 adds the selected option to the PDC 203. The intermediate data editing unit 207 then selects the next option, and the process returns to step S504. If the option added to the PDC 203 in step S506 is the last option in the capability information 601 of the printer 102 acquired in step S501, the function addition process ends, and the PDC editing process is completed.

As described above, the intermediate data editing unit 207 adds to the PDC 203 options for functions that are not supported by the general-purpose printing software 202 but are supported by the printer 102 and the extension application 204. The PC is generated based on the PDC 203 edited through the PDC editing process described above. Furthermore, the print setting screen extension unit 205 generates display data for the advanced settings screen 304 based on the PC. As a result, it becomes possible to display the advanced settings screen 304 that allows the user to configure functions not supported by the general-purpose printing software 202 but supported by the printer 102 and the extension application 204.

A description will now be given of a fax transmission control process from the point at which the host computer 101 receives fax settings to the point at which the printer 102 performs fax transmission.

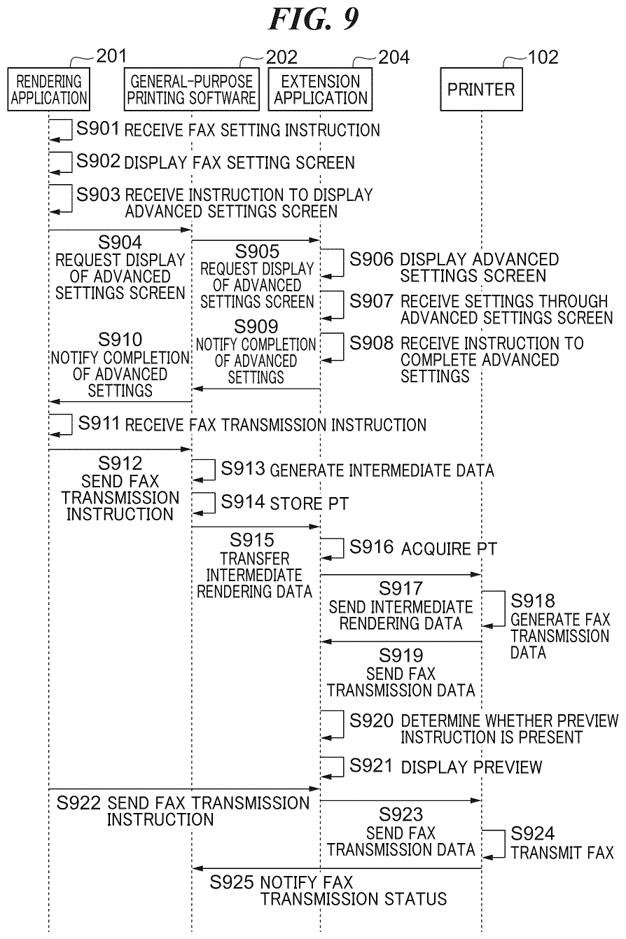

FIG. 9 is a sequence diagram illustrating an example of the fax transmission control process performed by the host computer 101 and the printer102 illustrated in FIG. 1. The operation of the host computer 101 illustrated in FIG. 9 is implemented by the CPU 111 controlling the rendering application 201, the general-purpose printing software 202, and the extension application 204. The operation of the printer 102 illustrated in FIG. 9 is implemented by the CPU (not illustrated) of the printer 102 executing a program stored in a ROM (not illustrated) or the like of the printer 102. In this embodiment, the fax transmission control process is described for a configuration in which the host computer 101 includes the extension application 204, as illustrated in FIG. 2B described above. In addition, it is assumed in the fax transmission control process of FIG. 9 that the PDC editing process described above with reference to FIG. 5 has already been performed. Through the PDC editing process, the PDC 203 has been supplemented with options for functions that are not supported by the general-purpose printing software 202 but are supported by the printer 102 and the extension application 204 (e.g., the fax preview function).

Referring to FIG. 9, first, in step S901, the rendering application 201 receives a fax setting instruction from the user. The fax setting instruction is an instruction for specifying settings used in a fax transmission process to be performed by the printer 102 connected to the host computer 101. In this embodiment, the user can provide the fax setting instruction to the rendering application 201 by operating the pointing device 117 or the keyboard 118.

Next, in step S902, the rendering application 201 causes the display 119 to display the fax setting screen 301 illustrated in FIG. 3A.

Subsequently, in step S903, the rendering application 201 receives an instruction to display the advanced settings screen. In this embodiment, the user can provide the instruction to display the advanced settings screen by operating the pointing device 117 or the keyboard 118 to select the advanced settings button 302 on the fax setting screen 301.

In step S904, the rendering application 201 issues a request to the general-purpose printing software 202 to display the advanced settings screen according to the received instruction to display the advanced settings screen.

In step S905, the general-purpose printing software 202 issues a request to the extension application 204 to display the advanced settings screen in response to the received display request.

In step S906, the print setting screen extension unit 205 of the extension application 204 causes the display 119 to display the advanced settings screen 304 illustrated in FIG. 3B in response to the received display request. Specifically, the print setting screen extension unit 205 causes the display 119 to display the advanced settings screen 304 with reference to the PC generated based on the PDC 203, to which options for functions such as the fax preview function have been added in the PDC editing process described above in connection with FIG. 5.

In step S907, the print setting screen extension unit 205 receives the settings specified by the user on the advanced settings screen 304. For example, as illustrated in FIG. 3B, if the user sets the paper size to A4, the image quality to standard, and the layout to 1-in-1, setting values indicating these settings are stored in the RAM 113.

In step S908, the print setting screen extension unit 205 receives an instruction from the user to complete the advanced settings. In this embodiment, the user can provide the instruction to complete the advanced settings by operating the pointing device 117 or the keyboard 118 to select an OK button 309.

In step S909, the extension application 204 notifies the general-purpose printing software 202 of the completion of the advanced settings.

Upon receiving the notification, the general-purpose printing software 202 switches the screen of the display 119 to the fax setting screen 301. Subsequently, in step S910, the general-purpose printing software 202 notifies the rendering application 201 of the completion of the advanced settings.

In step S911, the rendering application 201 receives a fax transmission instruction from the user. In this embodiment, the user can provide the fax transmission instruction by operating the pointing device 117 or the keyboard 118 to select the send button 303 on the fax setting screen 301.

In step S912, the rendering application 201 issues a fax transmission instruction to the general-purpose printing software 202.

In step S913, the general-purpose printing software 202 generates intermediate data using a module of the OS of the host computer 101. The intermediate data is generated based on the setting values stored in the RAM 113 in step S907 and the like.

In step S914, the general-purpose printing software 202 stores a PT included in the intermediate data generated in step S913 in the shared information 208.

In step S915, the general-purpose printing software 202 transfers intermediate rendering data, which is part of the intermediate data generated in step S913, to the extension application 204.

In step S916, the intermediate data editing unit 207 of the extension application 204 acquires the PT stored in step S914 from the shared information 208.

In step S917, the intermediate data editing unit 207 sends the intermediate rendering data to the printer 102. The intermediate data editing unit 207 also sends the PT acquired in step S916 to the printer 102. In this embodiment, the intermediate rendering data and the PT may be sent to the printer 102 as separate files, or alternatively, a single file containing both the intermediate rendering data and the PT may be sent to the printer 102.

In step S918, the printer 102 generates fax transmission data using the intermediate rendering data and the PT.

In step S919, the printer 102 sends the generated fax transmission data to the intermediate data editing unit 207 of the extension application 204.

In step S920, the print setting screen extension unit 205 of the extension application 204 determines whether a preview instruction is present. For example, if the setting value for a preview setting item 308 on the advanced settings screen 304 is “On,” it is determined that a preview instruction is present. On the other hand, if the setting value for the preview setting item 308 on the advanced settings screen 304 is “Off,” it is determined that no preview instruction is present.

If it is determined that no preview instruction is present, the preview 311 is not displayed, and the process proceeds to step S923. If it is determined that a preview instruction is present, the process proceeds to step S921.

In step S921, the print setting screen extension unit 205 of the extension application 204 displays the preview 311 overlaid on the fax setting screen 301, as illustrated in FIG. 3F. The preview 311 represents an image based on the fax transmission data generated in step S918.

If the cancel button 313 on the preview 311 is selected by the user, the process ends. If the OK button 312 on the preview 311 is selected by the user, the rendering application 201 issues a fax transmission instruction to the extension application 204 (step S922).

In step S923, the intermediate data editing unit 207 of the extension application 204 sends the fax transmission data received in step S919 to the printer 102.

In step S924, the printer 102 transmits the received fax transmission data via fax to one or more destinations specified by the user.

In step S925, the printer 102 notifies the general-purpose printing software 202 of the host computer 101 of a fax transmission status indicating the success or failure of the fax transmission process. After that, the process ends.

In the fax transmission control process described above with reference to FIG. 9, in step S918, the printer 102 may generate the fax transmission data only when the received PT indicates that all selected functions are supported by the printer 102. In such a configuration, for example, if a function that is not supported by the printer 102 but is supported by the extension application 204 is selected, the fax transmission data is not generated by the printer 102. In this case, the general-purpose printing software 202 or the extension application 204 may generate the fax transmission data using the intermediate rendering data and the PT.

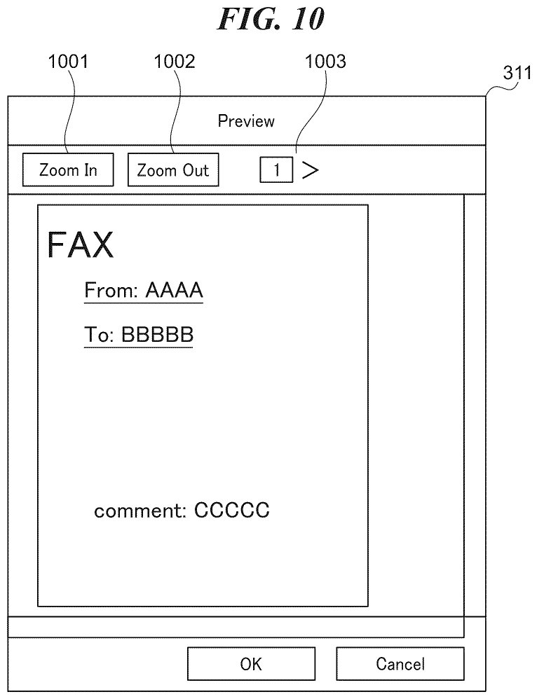

The preview 311 displayed in step S921 will be described below with reference to FIGS. 10 to 13B.

For example, when the setting value for the cover sheet is set to “ON” on the advanced settings screen 304, an image of a pre-registered cover sheet is displayed as the preview 311, as illustrated in FIG. 10. The user can perform a scaling operation on the image displayed in the preview 311 by selecting a zoom-in button 1001 or a zoom-out button 1002 in the preview 311. In addition, the user can display an image of the next page in the preview 311 by selecting a page forward button 1003 in the preview 311.

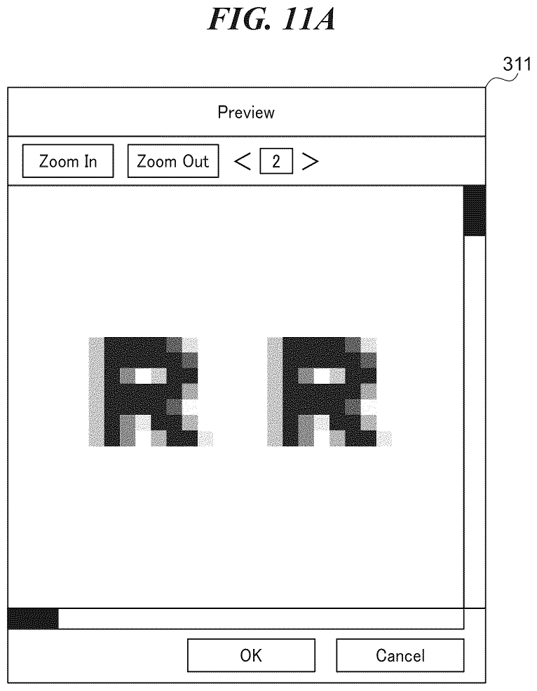

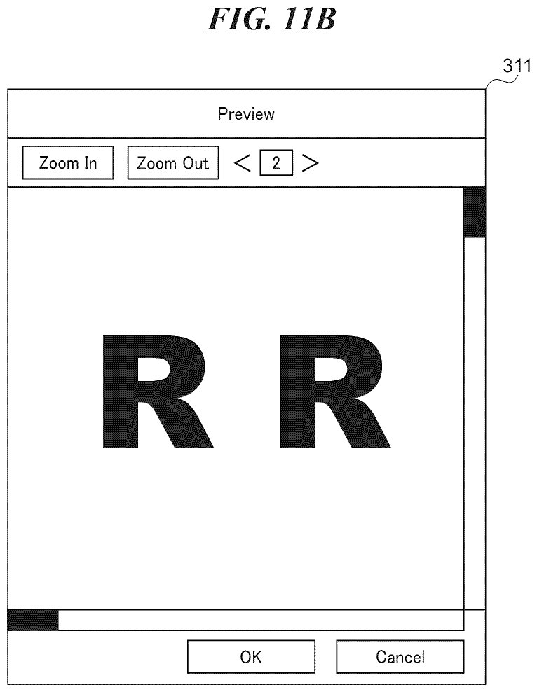

When a setting value is specified for the image quality on the advanced settings screen 304, an image with a resolution corresponding to the specified setting value is displayed as the preview 311. For example, when a low-resolution setting value is specified for the image quality on the advanced settings screen 304, a low-resolution image corresponding to the specified setting value is displayed as the preview 311, as illustrated in FIG. 11A. Conversely, when a high-resolution setting value is specified for the image quality on the advanced settings screen 304, a high-resolution image corresponding to the specified setting value is displayed as the preview 311, as illustrated in FIG. 11B.

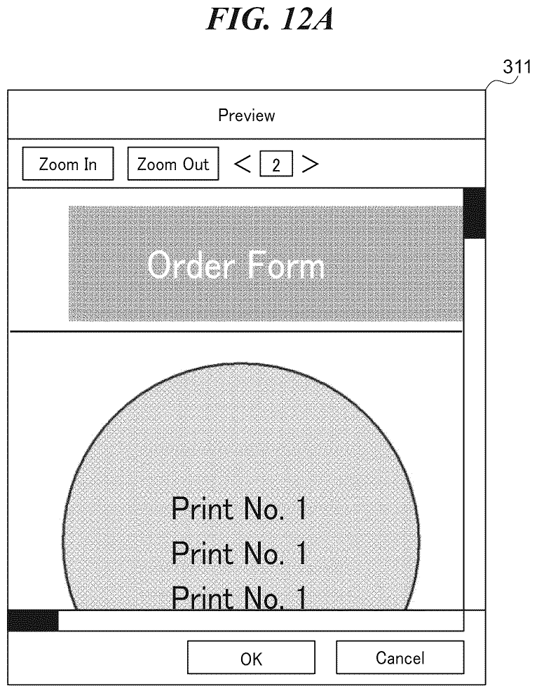

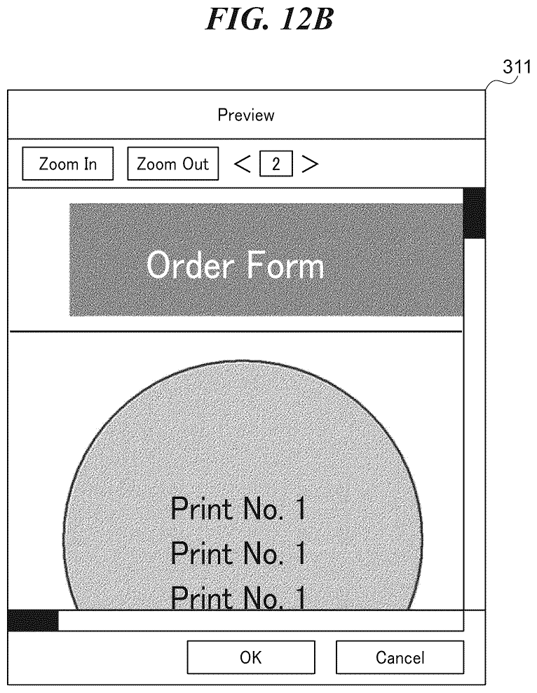

When a setting value is specified for the error diffusion function on the advanced settings screen 304, an image corresponding to the specified setting value is displayed as the preview 311. FIG. 12A is a diagram illustrating an example of an image displayed as the preview 311 when the error diffusion function is set to “Off.” FIG. 12B is a diagram illustrating an example of an image displayed as the preview 311 when the error diffusion function is set to “On.” When the error diffusion function is set to “On,” the image appears grainy, whereas when the error diffusion function is set to “Off,” gradation is expressed with periodic dots. It can be seen that the text “Order Form” in the image in FIG. 12B is more legible compared to that in FIG. 12A. To communicate information more clearly and without misunderstandings, it is preferable to set the error diffusion function to “On.”

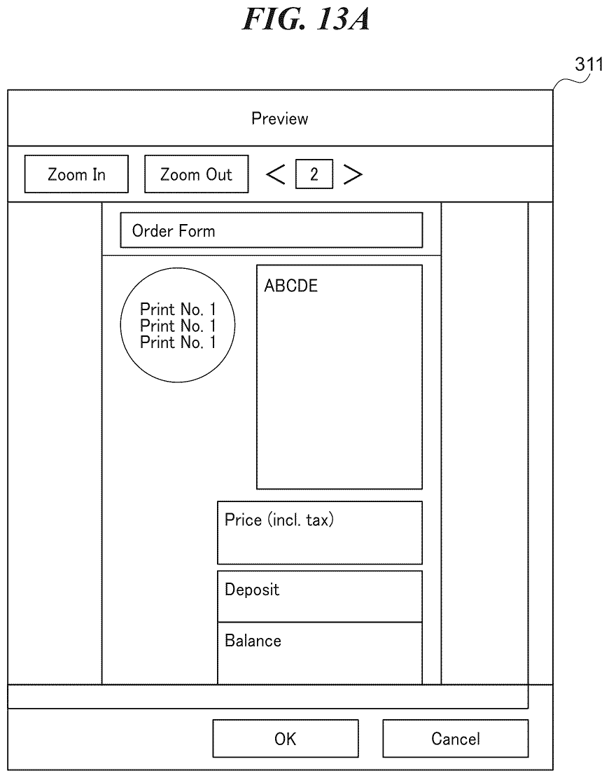

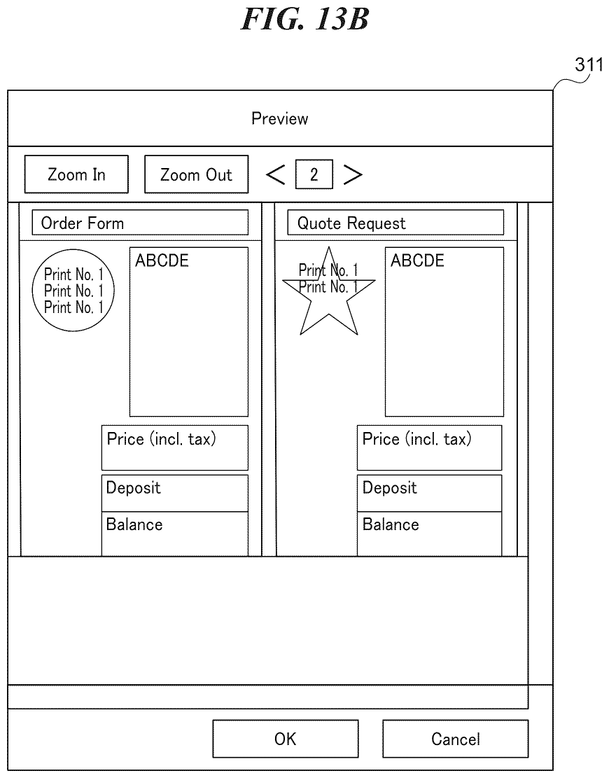

When a setting value is specified for the layout function on the advanced settings screen 304, an image corresponding to the specified setting value is displayed as the preview 311. FIG. 13A is a diagram illustrating an example of an image displayed as the preview 311 when the layout function is set to “1-in-1.” FIG. 13B is a diagram illustrating an example of an image displayed as the preview 311 when the layout function is set to “2-in-1.” In FIG. 13B, an image that combines two pages into a single page is displayed, which reduces data volume and improves overall viewability. However, there are concerns that fine lines may disappear and the legibility of small text may decrease due to the reduction in size.

A description will now be given of the detailed operation of the extension application 204 in the fax transmission control process described above.

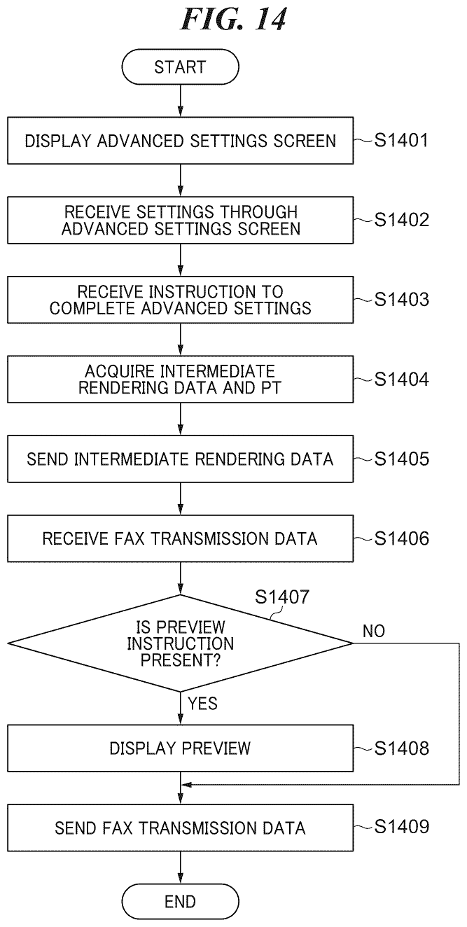

FIG. 14 is a flowchart illustrating the procedure of a support process performed by the extension application 204 illustrated in FIG. 2B. The support process illustrated in FIG. 14 is implemented by the CPU 111 controlling the extension application 204. The support process in FIG. 14 includes the above-mentioned steps S906 to S909, S916 to S917, S920 to S921, and S923.

Referring to FIG. 14, first, in step S1401, the print setting screen extension unit 205 of the extension application 204 causes the display 119 to display the advanced settings screen 304 illustrated in FIG. 3B in response to a request to display the advanced settings screen received from the general-purpose printing software 202. For example, refer to the aforementioned step S906.

Next, in step S1402, the print setting screen extension unit 205 receives the settings specified by the user on the advanced settings screen 304. For example, refer to the aforementioned step S907.

In step S1403, the print setting screen extension unit 205 receives an instruction from the user to complete the advanced settings. For example, refer to the aforementioned step S908. Subsequently, the extension application 204 notifies the general-purpose printing software 202 of the completion of the advanced settings. For example, refer to the aforementioned step S909.

Next, in step S1404, the intermediate data editing unit 207 of the extension application 204 acquires intermediate rendering data and a PT. For example, the intermediate data editing unit 207 acquires the intermediate rendering data output from the general-purpose printing software 202 in step S915. The intermediate data editing unit 207 also acquires the PT stored in step S914 from the shared information 208, as in step S916 described above.

In step S1405, the intermediate data editing unit 207 sends the intermediate rendering data to the printer 102. The intermediate data editing unit 207 also sends the PT acquired in step S1404 to the printer 102. For example, refer to the aforementioned step S917.

In step S1406, the intermediate data editing unit 207 receives fax transmission data generated by the printer 102.

In step S1407, the print setting screen extension unit 205 of the extension application 204 determines whether a preview instruction is present. For example, refer to the aforementioned step S920. If it is determined that no preview instruction is present, the process proceeds to step S1409. If it is determined that a preview instruction is present, the process proceeds to step S1408.

In step S1408, the print setting screen extension unit 205 of the extension application 204 displays the preview 311 overlaid on the fax setting screen 301, as illustrated in FIG. 3F. For example, refer to the aforementioned step S921. Examples of images displayed in the preview 311 are as illustrated in FIGS. 10 to 13B.

Next, in step S1409, the intermediate data editing unit 207 of the extension application 204 sends the fax transmission data received in step S1406 to the printer 102. After that, the process ends.

According to the embodiment described above, the host computer 101 includes the extension application 204 that supports the general-purpose printing software 202 and performs the support process illustrated in FIG. 14. In the support process, an image based on fax transmission data, which is generated according to the settings configured on the advanced settings screen 304, is displayed as the preview 311 on the display 119 before the printer 102 is caused to transmit the fax transmission data via fax. Thus, in a configuration where the general-purpose printing software 202 is used to control fax transmission, the user can preview and check the image based on the fax transmission data before performing fax transmission.

In the embodiment described above, the fax transmission data may be generated by the extension application 204. Thus, in a configuration where the extension application 204 generates the fax transmission data, the user can preview the image based on the fax transmission data before performing fax transmission.

In the embodiment described above, the fax transmission data may be generated by the general-purpose printing software 202. Thus, in a configuration where the general-purpose printing software 202 generates the fax transmission data, the user can preview the image based on the fax transmission data before performing fax transmission.

In the embodiment described above, an image based on the cover sheet settings specified on the advanced settings screen 304 may be displayed as the preview 311. This allows the user to preview the image of the specified cover sheet before performing fax transmission.

In the embodiment described above, an image based on the image quality settings specified on the advanced settings screen 304 may be displayed as the preview 311. This allows the user to preview the image corresponding to the specified image quality before performing fax transmission.

In the embodiment described above, an image based on the error diffusion settings specified on the advanced settings screen 304 may be displayed as the preview 311. This allows the user to preview the image corresponding to the specified error diffusion settings before performing fax transmission.

In the embodiment described above, an image based on the layout settings specified on the advanced settings screen 304 may be displayed as the preview 311. This allows the user to preview the image in which data for the specified number of pages is laid out on a single page before performing fax transmission.

While the extension application 204 is described in the above embodiment as being configured to acquire intermediate data generated by the general-purpose printing software 202, the configuration is not limited thereto. For example, the extension application 204 may be configured to generate the intermediate data.

Additionally, in this embodiment, when broadcast transmission is set to “ON” on the advanced settings screen 304, information on all specified destinations may be displayed as part of the preview 311, together with an image based on fax transmission data. This allows the user to preview the information on the specified destinations along with the image based on the fax transmission data before performing fax transmission.

Furthermore, in this embodiment, a configuration may be adopted in which the printer 102 generates fax transmission data to be transmitted via fax, and the host computer 101 generates separate fax transmission data to be displayed as the preview 311.

In the embodiment described above, the printer 102, which is equipped with a fax function, generates fax transmission data and sends the fax transmission data to the extension application 204 to display the preview 311 on the display 119. However, it may sometimes be difficult to send data generated by the printer 102 to the extension application 204 due to communication costs or performance issues.

Accordingly, a configuration will be described below in which the printer 102 generates fax transmission data to be transmitted via fax, and the host computer 101 generates separate fax transmission data to be displayed as the preview 311. In this case, the hardware and software configurations of the host computer 101 are basically the same as those illustrated in FIGS. 1, 2A, and 2B described above; however, some aspects of the fax transmission control process differ. Therefore, the following description will focus on the aspects that differ from the fax transmission control process described above.

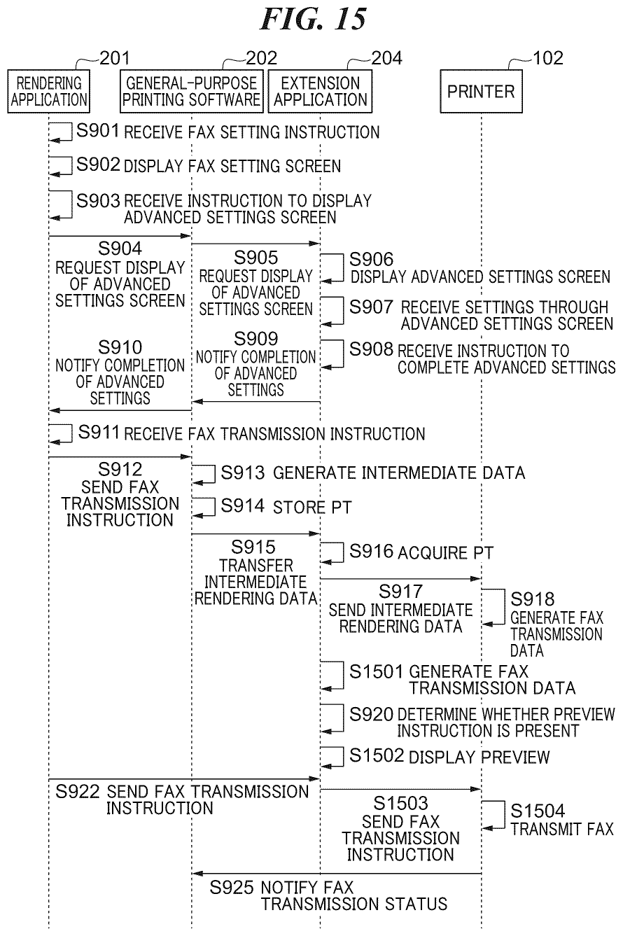

FIG. 15 is a sequence diagram illustrating another example of the fax transmission control process performed by the host computer 101 and the printer 102 illustrated in FIG. 1. The operation of the host computer 101 illustrated in FIG. 15 is also implemented by the CPU 111 controlling the rendering application 201, the general-purpose printing software 202, and the extension application 204, similarly to the operation of the host computer 101 described above with reference to FIG. 9. Likewise, the operation of the printer 102 illustrated in FIG. 15 is implemented by the CPU (not illustrated) of the printer 102 executing a program stored in a ROM (not illustrated) or the like of the printer 102, similarly to the operation of the printer 102 described above with reference to FIG. 9. The fax transmission control process to be described with reference to FIG. 15 also relates to a configuration in which the host computer 101 includes the extension application 204, as illustrated in FIG. 2B described above. In addition, it is assumed in the fax transmission control process of FIG. 15, as in that of FIG. 9, that the PDC editing process described above with reference to FIG. 5 has already been performed. Through the PDC editing process, the PDC 203 has been supplemented with options for functions that are not supported by the general-purpose printing software 202 but are supported by the printer 102 and the extension application 204 (e.g., the fax preview function).

Referring to FIG. 15, first, steps S901 to S918 described above are performed.

Next, in step S1501, the intermediate data editing unit 207 of the extension application 204 generates fax transmission data using the intermediate rendering data and the PT. Although this fax transmission data is generated based on the same data as the fax transmission data generated by the printer 102 in step S918, it is not used for the printer 102 to perform fax transmission; instead, it is used for display as the preview 311. In other words, in this embodiment, the printer 102 and the host computer 101 each generate fax transmission data based on the same data.

Step S920 described above is then performed. Subsequently, in step S1502, the print setting screen extension unit 205 of the extension application 204 displays the preview 311 overlaid on the fax setting screen 301, as illustrated in FIG. 3F. The preview 311 represents an image based on the fax transmission data generated in step S1501. This is followed by the aforementioned step S922.

Next, in step S1503, the intermediate data editing unit 207 of the extension application 204 sends a fax transmission instruction to the printer 102, instructing the printer 102 to fax the fax transmission data generated by the printer 102 in step S918. In this manner, the fax transmission control process of FIG. 15 differs from the fax transmission control process described above with reference to FIG. 9. Specifically, in FIG. 9, fax transmission data is sent to the printer 102 in step S923, whereas in FIG. 15, a fax transmission instruction, which is smaller in data size than the fax transmission data, is sent to the printer 102. As a result, the amount of data transmitted can be reduced.

Next, in step S1504, the printer 102 transmits via fax the fax transmission data generated in step S918 to one or more destinations specified by the user, according to the received fax transmission instruction. Subsequently, the aforementioned step S925 is performed, and the process then ends.

According to the embodiments described above, in a configuration where a standard driver is used to control fax transmission, the user can preview an image based on fax transmission data before performing fax transmission.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-165127, filed Sep. 24, 2024, which is hereby incorporated by reference herein in its entirety.

What is claimed is:

1. A computer program product configured to support a standard driver provided by a provider of an operating system and comprising a non-transitory computer-readable medium having stored thereon computer-executable instructions which, when executed by a processor of an information processing apparatus, cause the information processing apparatus to:
receive a facsimile setting; and
display, on a display of the information processing apparatus, an image based on facsimile transmission data generated according to the facsimile setting, before causing an image forming apparatus which is able to communicate with the information processing apparatus to transmit the facsimile transmission data via facsimile.

2. The computer program product according to claim 1, wherein the instructions further cause the information processing apparatus to generate the facsimile transmission data.

3. The computer program product according to claim 1, wherein the facsimile transmission data is generated by the standard driver.

4. The computer program product according to claim 2,
wherein the instructions further cause the information processing apparatus to:
send data for generating the facsimile transmission data to the image forming apparatus; and
send an instruction to the image forming apparatus to transmit, via facsimile, facsimile transmission data generated by the image forming apparatus based on the data, and
wherein the image displayed on the display is based on the facsimile transmission data generated by the information processing apparatus.

5. The computer program product according to claim 3,
wherein the instructions further cause the information processing apparatus to:
send data for generating the facsimile transmission data to the image forming apparatus; and
send an instruction to the image forming apparatus to transmit, via facsimile, facsimile transmission data generated by the image forming apparatus based on the data, and
wherein the image displayed on the display is based on the facsimile transmission data generated by the information processing apparatus.

6. The computer program product according to claim 1,
wherein the facsimile setting includes a setting related to a cover sheet to be included in the facsimile transmission data, and
wherein the image displayed on the display is based on the setting related to the cover sheet.

7. The computer program product according to claim 1,
wherein the facsimile setting includes a setting related to image quality of the facsimile transmission data, and
wherein the image displayed on the display is based on the setting related to the image quality.

8. The computer program product according to claim 1,
wherein the facsimile setting includes a setting related to error diffusion that simulates intermediate colors in a process of reducing the number of image colors or tones, and
wherein the image displayed on the display is based on the setting related to the error diffusion.

9. The computer program product according to claim 1,
wherein the facsimile setting includes a setting related to a function to arrange data for multiple pages on a single sheet for printing, and
wherein the image displayed on the display is based on the setting related to the function.

10. The computer program product according to claim 1,
wherein multiple destinations are specified in the facsimile setting, and
wherein information on all the specified destinations is displayed together with the image based on the facsimile transmission data.

11. An information processing apparatus, comprising:
an operating system;
one or more processors;
a display; and
a computer program product configured to support a standard driver provided by a provider of the operating system, the computer program product comprising at least one memory coupled to the one or more processors and having stored thereon instructions which, when executed by the one or more processors, cause the one or more processors to:
receive a facsimile setting; and
display, on the display, an image based on facsimile transmission data generated according to the facsimile setting, before causing an image forming apparatus which is able to communicate with the information processing apparatus to transmit the facsimile transmission data via facsimile.

12. A method of controlling an information processing apparatus that includes an operating system and a computer program product configured to support a standard driver provided by a provider of the operating system, the method comprising:
receiving a facsimile setting; and
displaying, on a display of the information processing apparatus, an image based on facsimile transmission data generated according to the facsimile setting, before causing an image forming apparatus which is able to communicate with the information processing apparatus to transmit the facsimile transmission data via facsimile.
